(19) United States
(12) Patent Application Publication
(10) Pub. No.: US 2020/0300115 A1
(43) Pub. Date: Sep. 24, 2020

(54) Cooling Of Rotor And Stator Components Of A Turbocharger Using Additively Manufactured Component-Internal Cooling Passages

(71) Applicant: MAN Energy Solutions SE, Augsburg (DE)

(72) Inventors: Lutz Aurahs, Langweid (DE); Stefan Weihard, Augsburg (DE); Christoph Leitenmeier, Augsburg (DE); Claudius Wurm, Augsburg (DE); Stefan Rost, Augsburg (DE)

(73) Assignee: MAN Energy Solutions SE

(21) Appl. No.: 16/820,392

(22) Filed: Mar. 16, 2020

(30) Foreign Application Priority Data
Mar. 18, 2019 (DE) 10 2019 106 733.2

(51) Int. Cl. F01D 25/12

(52) U.S. Cl. CPC F01D 25/12; F05D 2220/40; F05D 2230/50; F05D 2240/10; F05D 2260/20; F05D 2240/20

(57) ABSTRACT

A turbocharger includes a turbine and a compressor, each of which includes a rotor and a stator. At least one of the respective rotors and/or stators includes at least one interior flow passage at least partly or completely surrounded by a wall that provides cooling. The respective rotor and/or stator having the at least one flow passage is at least partly produced by additive manufacturing.

### BACKGROUND OF THE INVENTION

### 1. Field of the Invention

The invention relates to a turbocharger having a turbine and a compressor, each comprising a rotor and a stator and at least one of the respective rotors and/or stators comprising at least one interior flow passage for cooling. Furthermore, the invention relates to a method for producing such a turbocharger.

### 2. Description of the Related Art

The cooling of turbochargers with a turbine, which drives a compressor, is effected, according to the current state of the art, by conducting cooling media through long bores or large-volume cavities of a casting mould. Because of the applied manufacturing technologies and production methods, the applicable cooling concepts are greatly restricted at present. An internal cooling and a film cooling of rotor and stator components, which are correspondingly employed in gas turbines and aviation turbines; cannot be carried out with these production methods because of the complex geometry of the cooling passages. Disadvantageous in these cooling concepts for turbochargers is, on the one hand, the high thermal loading of the components of the turbocharger and, on the other hand, that a further efficiency optimization of these components is not possible. A suitable cooling concept offers substantial improvement potential of the efficiency of the turbocharger.

### SUMMARY OF THE INVENTION

It is therefore an object of the present invention to provide a turbocharger and a method for producing a turbocharger which, by a suitable cooling concept, reduces the thermal loading of the components of the turbocharger while further optimizing the efficiency.

According to an aspect of the present invention, this object may be solved by a turbocharger having a turbine and a compressor, each of which comprise a rotor and a stator. Here, at least one of the respective rotors and/or stators comprises at least one interior flow passage for cooling, which at least partly or completely, is surrounded by a wall. The respective rotor and/or stator comprising at least one flow passage is at least partly produced by additive manufacturing. By the additive manufacturing, the flow passage can be optimally designed for cooling the relevant component. In this manner, a more intensive cooling of the turbocharger components is made possible, which in turn has as consequence an improvement of the lifespan of components of compressor and turbine subjected to thermal load. It is advantageous, furthermore, that this leads to a more intensive cooling of the surfaces involved in the compressor process. Because of this, the compression efficiency is improved. Consequently, this is particularly advantageous for applications with high energy densities and high demands on the turbocharger efficiency.

In an advantageous aspect the flow passage and/or the wall surrounding the respective flow passage has been entirely produced or created by additive manufacturing. In forming the flow passage by additive manufacture it is favorable that the flow passage and thus also the cooling medium employed can be conducted through complex component geometries.

Preferentially, the turbocharger is configured so that the respective flow passage follows a complex course having multiple or a multiplicity of flow directional changes. In this way, the cooling of the relevant component is further improved.

In an exemplary aspect of the invention the respective flow passage, at least in certain sections, follows a course near the wall in a wall within the relevant rotor and/or stator which, at least partly or completely, surrounds the flow passage. Because of the cooling media conduction near the wall thus made possible a high degree of heat exchange is achieved and the efficiency of the turbocharger is further increased.

Furthermore, in a particularly favorable aspect the rotor of the turbine comprises a turbine hub and at least one turbine blade. The flow passage runs within the turbine hub at least axially and within the turbine blade. This is particularly advantageous to lower the material temperature of these components or to introduce sealing cooling air or film cooling air.

In a further advantageous aspect, the rotor of the compressor comprises a compressor wheel and at least one compressor blade. Here, the flow passage runs within the compressor wheel and the at least one compressor blade. Because of this, the material temperature in the compressor wheel and in the compressor blades can be further lowered or also extract heat from the compression process. In order to further improve the cooling effect and thus also the efficiency of the turbocharger, the conduction of the cooling medium within the rotor of the compressor and the turbine can be combined.

The turbocharger according to an aspect of the invention is configured so that the turbocharger comprises a housing and the flow passage runs within the housing. Here, the housing is at least partly or completely produced by additive manufacturing. By way of an additional cooling of the turbocharger housing or of stator components, the material temperature of the housing components or of the stator components or of the compressor wheel can be reduced and heat dissipated from the compression process at the same time.

It is advantageous, furthermore, when the flow passage comprises an inlet, which forms an opening for receiving a cooling fluid into the flow passage, and an outlet, which forms an opening for letting the cooling fluid out of the flow passage. In this way, a cooling medium can be introduced into or discharged out of the flow passage in the desired position. A suitable positioning of inlet and outlet of a flow passage has a major influence on its design and conduction through the corresponding component and consequently also on the cooling performance. Because of the additive manufacture, inlet and outlet can be positioned as desired and the efficiency can thus be improved.

In a further development of the invention of the present turbocharger, the inlet and the outlet comprise a multiplicity of openings into the flow passage, which are arranged spaced apart from one another. In this manner, an even entry or exit of the cooling medium is ensured and, because of the improved flow of the cooling medium or the improved cooling performance, the efficiency of the turbocharger is optimized.

According to an aspect of the invention, a method for producing a turbocharger described above is proposed, furthermore, with which the respective rotor or stator comprising the interior flow passage is produced by additive manufacture in particular by a 3D printing method for forming the corresponding flow passage. By additive manufacturing methods, the flow passage can be accurately matched to the requirements of the optimal cooling of the turbocharger components. The cooling performance can therefore be exactly matched to the respective application case and all turbochargers and turbocharger applications can benefit from the thermal household thus optimized.

In an advantageous embodiment version of the method it is provided that the housing or stator components are produced by additive manufacture in particular by 3D printing. In an additional manufacture of the housing by additive manufacturing it is favorable that by way of this the number of the applicable cooling concepts is expanded. Through the additional cooling of the housing or of stator components, heat can be additionally discharged out of the compression process. Furthermore, the material temperature of the housing components or of the stator components or of the compressor wheel is reduced.

Preferentially, the method is carried out so that the respective flow passage of the rotor, of the stator or of the housing, dependent on the required cooling capacity, is formed through a multiplicity of flow passage sections with different flow direction. With this configuration of the flow passage, the cooling performance of the fluid passage can be matched for the relevant turbocharger component exactly to the relevant requirement.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

Other advantageous further developments of the invention are shown in more detail by way of the figures together with the description of the preferred embodiment of the invention. In the drawings:

FIG. 1A is a schematic diagram of a turbocharger;

FIG. 1B is a sectional view of a rotor with additively cooling air conduction into the turbine;

FIG. 2 is a sectional view of a rotor with additively manufactured cooling air conduction into the compressor;

FIG. 3 is a perspective view of a stator of an axial turbine with additively manufactured cooling air conduction; and

FIG. 4 is a sectional view of a turbocharger housing with additively manufactured cooling air conduction.

### DETAILED DESCRIPTION OF THE PRESENTLY PREFERRED EMBODIMENTS

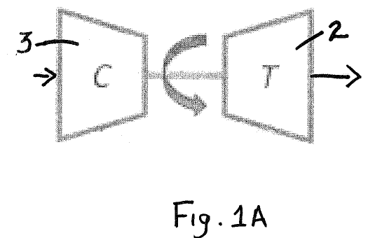

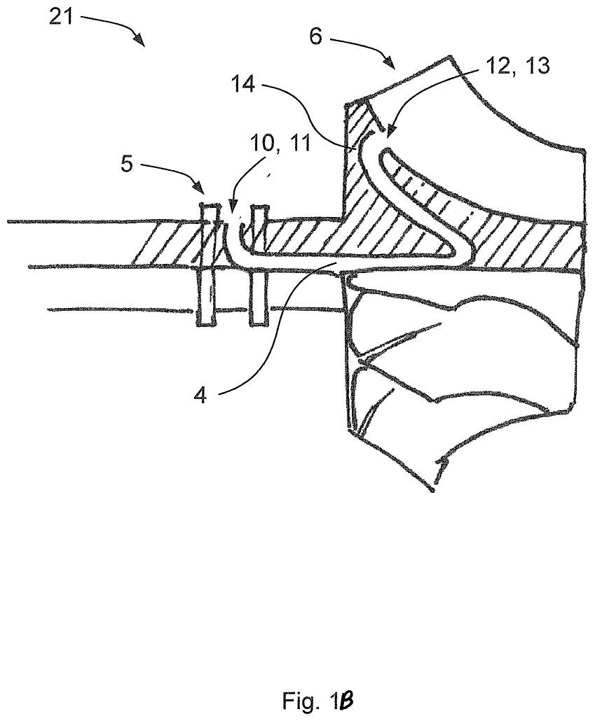

FIG. 1A is a schematic view of a turbocharger 1 having a turbine 2 and a compressor 3.

FIG. 1B is a sectional view of a rotor 21 of a turbine 2 with an additively manufactured flow passage 4 into the turbine 2 is shown. Here, the interior flow passage 4 is completely surrounded by a wall 14. Both the flow passage 4 and also the wall 14 are completely produced by additive manufacturing. Furthermore, the rotor 21 of the turbine 2 comprises a turbine hub 5 and a multiplicity of turbine blades 6.

The flow passage 4 shown in FIG. 1B follows a complex course comprising multiple flow directional changes. In the region of the turbine hub 5, this flow passage 4 forms an inlet 10 with a corresponding opening 11 for receiving a cooling fluid into the flow passage 4. From this opening 11, the flow passage 4 initially runs radially in the direction of a center axis of the rotor 21 and subsequently follows an arc-shaped course so that a wall 14 bounding the flow passage 4 is arranged in the region of the center axis. From this arc-shaped section, the flow passage 4 runs further within the turbine hub 5 substantially parallel to the center axis in the axial direction of the rotor 21. This section adjoins a section following an S-shaped course of the flow passage 4, which runs within the turbine blades 6, until the flow passage 4 at an edge of a turbine blade 6 comprises an outlet 12, which in turn forms an opening 13 for letting the cooling fluid out of the flow passage 4. Moreover, the flow passage 4 follows a course near a wall in certain sections on a wall 14 completely surrounding the flow passage 4 within the turbine blades 6.

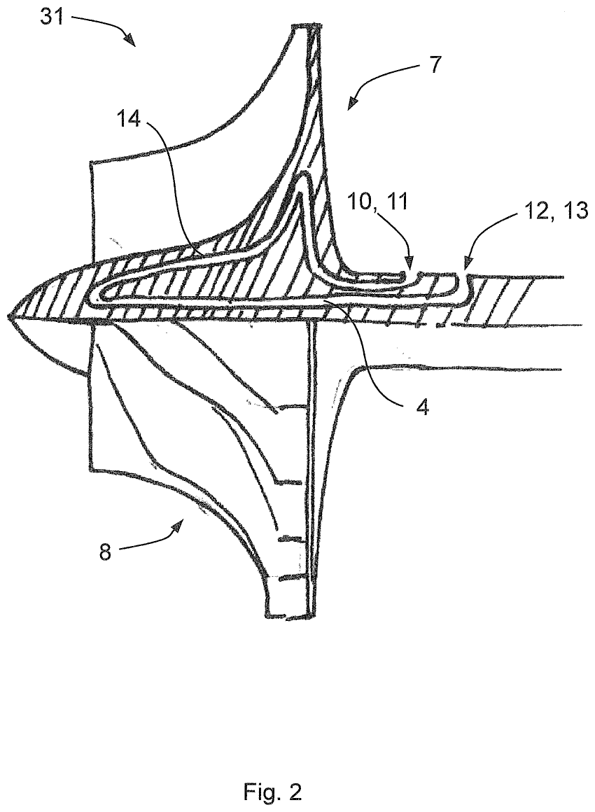

FIG. 2 shows a sectional view of a rotor 31 with additively manufactured cooling air conduction within a compressor 3, which comprises a compressor wheel 7 and multiple compressor blades 8. Here, the flow passage 4 runs within the compressor wheel 7 and at least one compressor blade 8. Emanating from an inlet 10 in the region of the compressor hub, which forms an opening 11 for receiving a cooling fluid into the flow passage 4, the flow passage 4 follows a complex course describing multiple flow-directional changes. In FIG. 2, the course of the flow passage 4 initially corresponds approximately to the geometry of the compressor blade surface, since the flow passage 4 follows a course near the wall within a wall 14 completely surrounding the flow passage 4. This section is followed by a part of the flow passage 4 which runs axially and parallel to the center axis of the rotor 31 and back to the compressor hub and subsequently describes an arc and runs to radially outside towards an outlet 12 with an opening 13 for letting the cooling fluid out of the flow passage 4.

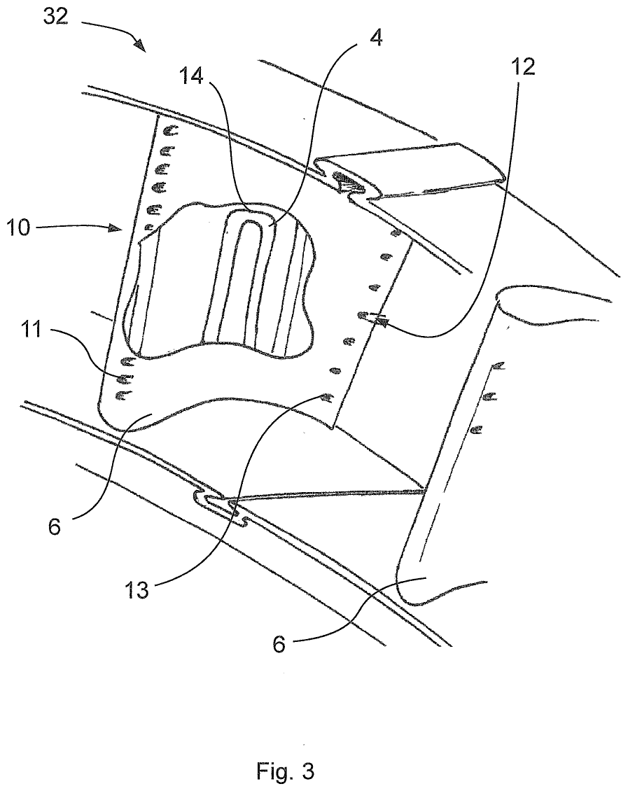

In FIG. 3, a perspective view of a stator 32 of an axial turbine with additively manufactured cooling air conduction is shown. In an edge region of the turbine blade 6, the flow passage 4 comprises an inlet 10 on which a multiplicity of openings 11 into the flow passage 4, spaced apart from one another, for receiving a cooling fluid is arranged. Following the respective opening 11, the flow passage 4 runs in a complex manner with multiple flow-directional changes and in certain sections near the wall in a wall 14 completely surrounding the flow passage 4 within the stator 32. The flow passage 4 terminates at an outlet 12 which in turn comprises a multiplicity of openings 13 spaced apart from one another for letting the cooling fluid out of the flow passage 4.

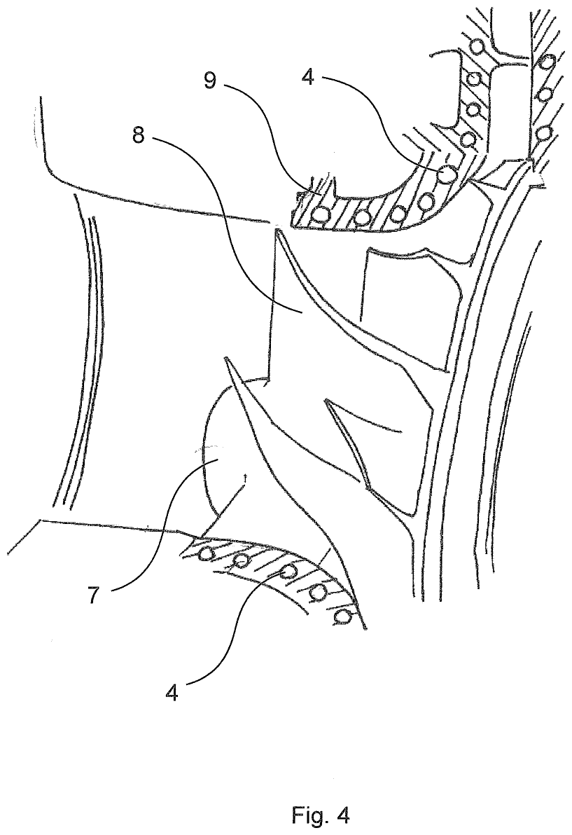

FIG. 4 shows a sectional view of a turbocharger having a housing 9, which comprises an additively produced cooling air conduction. Furthermore, the turbocharger comprises a compressor wheel 7 and multiple compressor blades 8. A flow passage 4 runs within the housing 9.

In its embodiment, the invention is not restricted to the preferred exemplary embodiments stated above. On the contrary, a number of versions is conceivable which make use of the shown solution even with embodiments of a fundamentally different type.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A turbocharger (1), comprising a turbine (2) and a compressor (3), each of the turbine (2) and the compressor (3) comprising a rotor (21, 31) and a stator (22, 32),
wherein at least one of the respective rotors (21,31) and/or stators (22/32) comprises at least one interior flow passage (4), the at least one interior flow passage being at least partly or completely surrounded by a wall (14) that provides cooling, and wherein the respective rotor (21, 31) and/or stator (22, 32) comprising the at least one flow passage (4) is at least partly produced by additive manufacturing.

2. The turbocharger (1) according to claim 1, wherein the flow passage (4) and/or the wall (14) surrounding the respective flow passage (4) is produced entirely by additive manufacturing.

3. The turbocharger (1) according to claim 1, wherein the respective flow passage (4) follows a course comprising a multiplicity of flow-directional changes.

4. The turbocharger (1) according to claim 1, wherein the respective flow passage (4) follows a course near the wall at least in certain sections in the wall (14) at least partly or completely surrounding the flow passage (4) within the respective rotor (21, 31) and/or stator (22, 32).

5. The turbocharger (1) according to claim 1, wherein the rotor (21) of the turbine (2) comprises a turbine hub (5) and at least one turbine blade (6), wherein the flow passage (4) runs within the turbine hub (5) at least axially and within the turbine blade (6).

6. The turbocharger (1) according to claim 1, wherein the rotor (31) of the compressor (3) comprises a compressor wheel (7) and at least one compressor blade (8), wherein the flow passage (4) runs within the compressor wheel (7) and the at least one compressor blade (8).

7. The turbocharger (1) according to claim 1, wherein the turbocharger (1) comprises a housing (9), wherein the flow passage (4) runs within the housing (9) and the housing (9) is produced at least partly or completely by additive manufacturing.

8. The turbocharger (1) according to claim 1, wherein the flow passage (4) comprises an inlet (10), which forms an opening (11) configured to receive a cooling fluid into the flow passage (4), and an outlet (12), which forms an opening (13) configured to let the cooling fluid out of the flow passage (4).

9. The turbocharger (1) according to claim 8, wherein the inlet (10) and the outlet (12) comprise a multiplicity of openings (11, 13) into the flow passage (4), which are arranged spaced apart from one another.

10. A method for producing a turbocharger (1) according to claim 1, wherein the respective rotor (21, 31) or stator (22, 32) comprising the interior flow passage (4) for forming the corresponding flow passage (4) is produced by additive manufacture by a 3D printing method.

11. The method for producing a turbocharger (1) according to claim 10, further comprising a housing (9), wherein the housing (9) is produced by additive manufacture by 3D printing.

12. The method for producing a turbocharger (1) according to claim 11, wherein the respective flow passage (4) of the rotor (21, 31), of the stator (22, 32) or of the housing (9) is formed by a multiplicity of flow passage sections with different flow direction dependent on the required cooling capacity.
